(19) United States
(12) Patent Application Publication
(10) Pub. No.: US 2009/0051659 A1
(43) Pub. Date: Feb. 26, 2009

(54) Computer Input Device

(76) Inventor: Phillip John Mickelborough, Wiltshire (GB)

Correspondence Address: LAW OFFICE OF MORRIS E. COHEN, 1122 CONEY ISLAND AVENUE, SUITE 217, BROOKLYN, NY, 11230, US

(21) Appl. No.: 11/793,515

(22) PCT Filed: Dec. 19, 2005
(86) PCT No.: PCT/GB05/04909

§ 371 Date: Jun. 20, 2007

(30) Foreign Application Priority Data
Dec. 20, 2004 (GB) 0427822.2
May 3, 2005 (GB) 0509017.0

(51) Int. Cl. G06F 3/041

(52) U.S. Cl. 345/173

(57) ABSTRACT

A device (1) for data entry into an electronic device such as a computer, personal digital assistant (PDA) or mobile phone is provided, comprising thumb and finger touch pads (5,3), arranged on the device in a pattern corresponding to the natural thumb and finger tip positions of the thumb and fingers when relaxed; each finger pad (3) extending in backward and forward directions; the thumb pad (5) extending in left and right directions; position detecting means to detect the position of the thumb and each finger tip along each of the thumb and finger pads (5,3); finger data selection means to select for each finger a character or instruction corresponding to the detected position of a finger tip when in contact with a finger pad (3); thumb option selection means to select an option corresponding to the detected position of the thumb when in contact with the thumb pad (5); selection display means to display the character or instruction selected on each finger pad (3) according to the option selected on the thumb pad (5); and data entry detecting means to detect lifting of a finger from a finger pad (3) and enter a character or instruction into the electronic device based on the character or instruction selected on the finger pad (3) for which lifting is detected and based on the option selected on the thumb pad (5). Instead of touch pads, pressure cups can be used.

### TECHNICAL FIELD

This invention relates to a device and method for entering characters or instructions into an electronic device such as a computer, personal digital assistant (PDA) or mobile telephone. This invention offers an alternative to conventional devices for entering characters or instructions into an electronic device, such as keyboards, keypads or touch screens.

### BACKGROUND ART

People frequently need to enter alphanumeric data, punctuation or instructions into an electronic machine. Generally, a computer user enters this using a keyboard and a pointing device such as a mouse or a touch pad, a mobile telephone user enters text and numbers using the phone's numerical keypad and a PDA user enters data using devices including a small keyboard or a pointing device on a touch screen.

Keyboards enable fast data entry if the operator can touch-type; that is to type while looking at the screen. Many users have not learnt this skill and rely on the slower technique known as “hunt and peck” which requires looking for each key and then looking back at the screen. This is slow, and the hand, arm, wrist and finger movements associated with keyboard usage are also associated with illnesses such as repetitive strain injuries.

Entering data via a mobile phone's keypad is slow as each key has to be pressed a number of times to present the required letter or number. Although a mobile phone keypad is smaller than a computer keyboard, it is large compared with the overall size of the phone and limits the size of screen that can be included. Small keypads are also more difficult to use for people with large fingers.

Keyboards on PDAs and small portable computers are difficult and slow to use because of their small size.

Most data entry methods require the use of two hands to achieve reasonable speeds of data entry.

There are various devices available to mitigate the problems caused by keyboards and keypads. Keyboards can be curved and angled to improve the angle at which the hands approach the keyboards, including natural keyboards and vertical-split keyboards where the palms of each hand face each other.

Dvorak keyboards are based on designs created by August Dvorak, who determined the most common letter combinations and then replaced the QWERTY pattern with a keyboard layout that reduces fatigue and speeds up typing. Expanded keyboards have large keys for the use of disabled people. Chording keyboards have ten or fewer keys, and the character is specified by the combination of keys that have been depressed. Projection keyboards use a laser to project the image of a keyboard onto a desk or other flat surface and cameras monitor the movement of the fingers over the keyboard image and determine which “key” was pressed.

Predictive typing is used to speed up the entry of text on a mobile telephone.

There are also mechanisms to replace keyboards, frequently designed for disabled people. One such device has ten pockets into which the fingers and thumbs are inserted horizontally. Each pocket can move approximately one centimetre in any of four directions (right, left, away and towards) and each such movement or combination of movements specifies a character to be entered.

Another device uses two “domes”, one for each hand. Each dome can move in one of eight directions, and the combination of these two sets of eight specifies the required character.

Eye-gaze technology determines where the eye is looking and uses eyelid movements to “click”. “Sip and puff” uses the breath to control cursor movement and to click. These two are often used with on-screen keyboards, where the eye-gaze or breath moves a cursor over the character to be selected.

Voice recognition software provides an alternative to the mechanical entry of data.

The present invention provides a further alternative for the entry of data into electronic devices, preferably using touch pad technology.

Touch pads are well-known as pointing devices, for example to enable a user to move a cursor to a desired position on a computer screen, by moving a finger along the surface of the pad, and to enter a selected character or instruction into the computer, for example by tapping the pad or by lifting the finger from the pad.

Touch pads are well-known technology which work by various principles including those known as capacitive, inductive and resistive. Capacitive touch pads work by placing a grid of wires beneath a non-conducting surface. The presence of a finger on the surface affects the capacitance of the grid at that point and so operating software can determine the centroid of the finger contact and allocate a value to that position in the form of X and Y co-ordinates. Touch pads also allocate values to other parameters including the contact area of the finger (as an indication of finger pressure). Touch pads usually combine a finger contact area with electronic components mounted on printed circuit boards to operate the software needed to analyse and report the output data. They usually report data according to PS/2, serial, USB, ADP or MEP protocols.

Other touch pads are available in a long but narrow format giving a single position co-ordinate along their long axis. These may be straight or any other open-ended or closed-ended shape, such as a letter “C”, a triangle or a ring shape.

### SUMMARY OF THE INVENTION

In a first aspect the invention provides a device for data entry into an electronic device, comprising:
a first thumb pad and two to four (preferably four) finger pads, arranged on the device in a pattern corresponding to the natural thumb and finger tip positions of the thumb and fingers when relaxed;
each finger pad extending in backward and forward directions from a reference point along a line or arc corresponding to the natural path of the finger tips followed when the fingers are flexed and extended;
the thumb pad extending in left and right directions from a reference point along a line or arc corresponding to the natural path of the thumb followed when the thumb is moved left and right;
position detecting means to detect the position of the thumb and each finger tip along each of the thumb and finger pads, wherein a plurality of positions in the backward direction and a plurality of positions in the forward direction from the reference point of each finger pad are detectable;
finger data selection means to select for each finger a character or instruction corresponding to the detected position of a finger tip when in contact with a finger pad;
thumb option selection means to select an option corresponding to the detected position of the thumb when in contact with the thumb pad;
selection display means to display the character or instruction selected on each finger pad according to the option selected on the thumb pad; and
data entry detecting means to detect tapping or lifting of a finger on or from a finger pad and enter a character or instruction into the electronic device based on the character or instruction selected on the finger pad for which tapping or lifting is detected and based on the option selected on the thumb pad.

For this aspect, preferably the data entry detecting means detects tapping of a finger on the finger pads.

In a second aspect, the invention provides a device for data entry into an electronic device, comprising:
a first thumb cup and two to four (preferably four) finger cups, arranged on the device in a pattern corresponding to the natural thumb and finger tip positions of the thumb and fingers when relaxed, the centre of each cup defining a reference point for each cup;
each finger cup having back and front sides disposed backwards and forwards from the reference point based on the natural path of the finger tips followed when the fingers are flexed and extended;
the thumb cup having left and right sides disposed leftwards and rightwards from the reference point based on the natural path of the thumb followed when the thumb is moved left and right;
pressure detecting means to detect the pressure exerted by the thumb and each finger tip on the sides of each of the thumb and finger cups, wherein a plurality of pressures on the back side and a plurality of pressures on the front side of each finger cup are detectable;
finger data selection means to select for each finger a character or instruction corresponding to the detected pressure of a finger tip when in pressure contact with a side of a finger cup; thumb option selection means to select an option corresponding to the detected pressure of the thumb when in pressure contact with a side of the thumb cup;
selection display means to display the character or instruction selected on each finger cup according to the option selected on the thumb cup; and
data entry detecting means to detect downward pressure of a finger on a finger cup and enter a character or instruction into the electronic device based on the character or instruction selected on the finger cup for which downward pressure is detected and based on the option selected on the thumb cup.

### DESCRIPTION OF THE INVENTION

This invention uses small movements or changes in pressure of the fingers of one or more hands each to select one of a plurality of characters or instructions for display on the screen of an electronic device and to select one of these displayed characters or instructions to be entered into the electronic device. In one aspect of the invention, the movement of each finger is made along one of a corresponding number of touch pads and the finger's position on its touch pad determines the character or instruction to be selected. The entry is effected by momentarily changing the pressure of the corresponding finger on the touch pad such as by tapping or lifting the corresponding finger. The position of the thumb on its own touch pad determines which of a plurality of sets of characters the fingers present for display. An alternative aspect of the invention uses pressure cups instead of touch pads. In this aspect, the finger tips and the thumb sit in small cups and the characters are changed by pressure on the front or back of the cup instead of movement, and character selection is by pressing downwards on the cup. The horizontal and vertical pressures are measured by means that may include pressure-sensitive semiconductors and piezo-electric devices.

The “position detecting means”, “pressure detecting means”, “finger data selection means”, “thumb option selection means”, “selection display means” and “data entry detecting means” as used herein are to be understood as referring to any suitable electronic (including software and/or hardware) or electromechanical means to enable data parameters representing the specified value (position value, pressure value, data selection value, option selection value, etc.) to be determined or processed. Suitable such means for use with touch pads or pressure cups are known or readily adapted using conventional technology by those skilled in the art.

Preferably, the number of finger pads or cups is four. Although four fingers and one thumb provide the optimum single-handed input, the device could be designed with more or fewer touch pads or cups.

The software and/or hardware for the device may be configured such that the device can automatically determine the reference points for each finger and thumb pad or cup, for example in a preliminary initialisation procedure, or can retrieve a user's reference points from a pre-stored or imported user profile. Alternatively, the reference points can be preset at defined positions or pressures, for example at the midpoints of finger and thumb pads.

The number of positions or pressures detectable in each of the backward and forward directions from the reference point for each finger pad or cup can be, for example, any number from 2 to 6, preferably from 3 to 5, and most preferably is 4. The number of positions or pressures detectable for the thumb pad or cup is any number from 2 to 8, preferably 4 to 6, more preferably 5. If desired, in particular in the device of the first aspect that uses a thumb pad, number of detectable positions can be arranged in one or two rows, for example a single of row of 6 positions or two rows of 3 giving a total of 6 positions. For example, four fingers each offering eight characters and four thumb positions make available 128 characters.

In an embodiment of the first or second aspects, the device further comprises a second thumb pad or cup, in which the two thumb pads or cups are disposed one on either side of the finger pads or cups, for either-handed data entry. In an alternative embodiment, the device has one large thumb pad positioned below the finger pads or cups, such that the thumb pad is accessible by a left hand thumb when a left hand is used to operate the device as well as being accessible by a right hand thumb when a right hand is used to operate the device, so as to enable either-handed data entry.

If desired, two devices of opposite- or either-handedness according to the invention may be used in paired combination, e.g. side by side, for two hand data entry. Each hand may enter its own set of characters or instructions into the electronic device, thus in principle doubling the range of different characters or instructions that may be entered. For example, an embodiment of the invention uses either two either-handed units or a left-handed and a right-handed unit so that all eight fingers select characters. The software enables the display to show either all selected characters or the most recently selected ones.

It will be appreciated that the device and method according to the invention is applicable to any electronic device requiring manual (finger/thumb) data entry, such as a desktop computer, laptop, electronic notebook, PDA, mobile phone, fixed telephone or calculator.

In an embodiment of the invention as applied to a mobile phone, the mobile phone has a thumb pad and four finger pads arranged on it, with the thumb pad disposed on one side face of the phone and the four finger pads disposed on the other side face of the phone. If desired, an additional pad can be provided for the ball of the thumb, preferably disposed on the same side face of the phone below the thumb pad, with the position detecting software and/or hardware for the device being so configured as to detect the ball of the thumb on its pad, and an electronic switch or other device activating means to activate the device only when the position detecting means has detected all of the thumb tip, finger tips and ball of the thumb on their respective pads. In a variant of this embodiment, the mobile phone is operable by the left hand or the right hand according to user choice, and has four touch pads on each side, with appropriate software to enable the user to operate the pads on one side as the finger pads and one or more of the pads on the other side as the thumb pad and optional thumb ball pad, or vice-versa.

In an embodiment of the invention as applied to a personal digital assistant (PDA), the PDA has a thumb pad and four finger pads arranged on it with the thumb pad disposed on a minor face of the PDA, such as the front side surface, and the four finger pads disposed on an external major face or, for example if the PDA is of the ‘clam-shell’ or similar foldable design, on an internal major face of the PDA.

In a further embodiment, the software and/or hardware for the device may be configured such that when no position or pressure is detected on one or two of the finger pads or cups, one or two of the other finger pads or cups and on the thumb pad serve as a pointing tool to point or move a cursor and enters instructions, based on positions or pressures detected those one or two other finger pads or cups and on the thumb pad or cup. Alternatively, the software and/or hardware for the device may be configured such that when no position or pressure is detected on the finger pads or cups, the thumb pad or cup serves as a pointing tool to point or move a cursor and enter instructions, based on positions or pressures detected on the thumb pad or cup.

Preferably, the software and/or hardware for the device is configured such that the device displays only the characters or instructions selected on each finger pad so as to show all selected characters or instructions or displays only the most recently selected character or instruction, according to the option selected on the thumb pad. The selected character(s) or instruction(s) may be displayed in a small window portion on a display screen. The window may be in a fixed position on the display screen as the characters or instructions are entered or, if desired, the software may configured to move the window progressively along with the character entry position or text cursor, or to any other contextually determined positions on the display screen as the characters or instructions are entered. If desired, the software may briefly highlight each entered character or instruction visually in the window and/or audibly confirm each entry by its character sound or by a click or bleep.

Alternatively, the software and/or hardware for the device may be configured such that the device can further display some or all of the characters or instructions available for selection on each finger pad according to the option selected on the thumb pad. The available selections may for example be displayed in an enlarged window, again in fixed or contextually moveable position on the display. For example, the enlarged window may display not only the characters or instructions selected but also unselected but available characters or instructions immediately one or more above and one or more below the selected characters or instructions.

In another variation, the enlarged window may display all the characters or instructions available for selection, according to the option selected on the thumb pad or cup. This would assist users in learning how to use the device. In the latter variant, selected characters may be shown framed or otherwise highlighted, with the highlighting moving up or down the columns of characters so as to reflect the position of the fingers up or down the finger pads or with the selected characters moving into a fixed position within the window, e.g. in a framed subwindow showing the selected characters.

Furthermore, if desired, the characters or instructions may be shown either to scroll smoothly, to ‘snap’ into place, or to change instantly from one character or instruction to the next into the highlighted area as the fingers move from one character or instruction selection to the next. If desired, movement of the fingers and/or thumb from one selection or option to the next can accompanied by an audible sound. Of course, the software and/or hardware may be such as to allow a user to choose between these and other variants and options on the same device by adopting different user-selectable set-ups and preferences.

Furthermore, for blind users, it may be desirable for the software to be configurable to audibly read out the characters or instructions as they are selected and entered, as an alternative to visually representing or highlighting the selected and entered characters or instructions on the screen.

It will be appreciated that the number of finger pads or cups, the number of selectable positions or pressures for each finger pad or cup, the number of selectable options on each thumb pad or cup, and the number of devices (one or two, i.e. single handed or double handed operation) will determine the range of characters and instructions that can be entered using the device, and the software and/or hardware for the device can therefore be configured or be programmable to set or vary these numbers accordingly, depending on the characters and instruction range capability desired for the device. The device can be pre-programmed or programmable with standard or bespoke character sets. For example the device may contain a default set of character sets, and/or be programmable with language-specific or personalised character sets, for example by conventional interfacing with the electronic device. In one example, a user key (“dongle”) containing a processor, memory and software storing desired character sets and other user data such as security features may be plugged into the device itself or into the electronic device with which the device communicates, e.g. via a USB port or other interface, to enable user-specific character sets to be adopted by the device. The device can thus also be configured to enter conventional character and instruction combinations, such as “sticky” characters which if selected and entered would affect the following character selected, e.g. a “shift” sticky key if selected and entered would result in the next character selected and entered being a capital letter, even if the capitals character set had not been selected using a thumb-selectable option. Furthermore, the device may be configured such that certain characters initiate macros if selected and entered. Furthermore, the device may be configured such that if a character is selected for a set period, for example a few seconds, the character is automatically entered instead of requiring a finger tapping for entry, to enable character entry for disabled users for whom tapping may be difficult. In this case, the finger pads would include a null finger position to allow the finer to rest without triggering a selection.

Sample character sets for a device that has four finger pads each having 8 finger positions and one thumb pad having 5 thumb positions are shown below in Tables 1 to 5. In each table, the four columns represent the selections available for each of the four fingers for a given thumb option selected:

TABLE 1
Lower case letters-Thumb at reference point
User selectable values

| | | | |
|---|---|---|---|
| A | i | q | y |
| B | j | r | z |
| C | k | s | . |
| D | l | t | space |
| E | m | u | backspace |
| F | n | v | enter |
| G | o | w | left click |
| H | p | x | right click |

TABLE 2
Upper case letters-Thumb at reference point +1
User selectable values

| | | | |
|---|---|---|---|
| A | I | Q | Y |
| B | J | R | Z |
| C | K | S | . |
| D | L | T | space |
| E | M | U | backspace |
| F | N | V | enter |
| G | O | W | left click |
| H | P | X | right click |

TABLE 3
Numbers and frequently-used punctuation-Thumb at
reference point −1
User selectable values

| | | | |
|---|---|---|---|
| 1 | 9 | ( | ? |
| 2 | 0 | ) | & |
| 3 | = | , | + |
| 4 | @ | . | space |
| 5 | # | ; | backspace |
| 6 | “ | : | enter |
| 7 | ” | ' | left click |
| 8 | − | / | right click |

TABLE 4
Other punctuation and tools letters-Thumb at
reference point −2
User selectable values

| | | | |
|---|---|---|---|
| ! | [ | Euro | Esc |
| £ | ] | www. | SysRq |
| $ | ~ | .com | PrtScr |
| % | < | Insert | space |
| \hat{ } | > | Delete | backspace |
| * | { | Scroll Lock | enter |
| _ | } | Pause | left click |
| + | \| | Break | right click |

TABLE 5
Modifier, movement and function keys letters-
Thumb at reference point +2
User selectable values

| | | |
|---|---|---|
| AltGr* | Home | |
| Alt* | PgUp | |
| Windows | PgDn | Context |
| logo* | | menu key |
| Function* | CrRt | Shift* |
| Crtl* | CrLt | tab right |
| Crtl-Alt* | CrUp | tab left |
| Ctrl-shift* | CrDn | |
| Macro* | End | |

*indicates sticky keys

If desired, the device may also include conventional features commonly found on a computer, such as interface ports (e.g. USB), on/off switch, hard keys and pointing devices such as a touch pad, joystick or tracker ball.

Although the device is shown in embodiments herein as lying substantially horizontal, the device may if desired be mounted so as to be oriented in an ergonomically desirable position, e.g. in a substantially vertical or other non-horizontal plane. If desired, the mounting can be adjustable to enable the device to be oriented in any number of positions. Furthermore, although the device is shown in embodiments herein as having the finger pads or cups lying in the same plane, the finger and thumbs pads or cups may if desired be arranged ergonomically in mutually different planes such as on or around a curved surface (for example on a handle or joystick). Thus, the device need not be constructed around a flat base, but may be any shape that is comfortable and allows the requisite finger movements. In some embodiments the touch pads may be arranged around shapes of base that include, but are not limited to, part of a ball or the shape of a computer mouse.

The device when applied to a computer preferably also includes a wrist support, e.g. supporting the base of the hand, to reduce any risk of repetitive strain injury. If desired, the wrist support may be linked to means for controlling the power supply or power management for the device, for example a power ‘on/off’ switch or power ‘stand-by’ switch, so that the power may be switched on or off, or otherwise controlled, by the user through the wrist support.

The device may communicate with the electronic device through integrated hardware and/or compatible software, e.g. in the same appliance (e.g. mobile phone, PDA, laptop), or separately (e.g. desktop computer) via physical connector or wireless means (infrared, Bluetooth™) in conventional manner.

The invention will be further explained by the description of the embodiments below and by reference to the embodiments shown in the accompanying drawings.

### BRIEF DESCRIPTION OF THE DRAWINGS

FIG. 1 shows a top-view of a device of the invention for right-handed use.

FIG. 2 shows a computer screen with the four selected characters displayed using a device of the invention.

FIG. 3a shows a top view of a device of the invention for either-handed use.

FIG. 3b shows a top view of an alternative device of the invention for either-handed use.

FIG. 4 shows the front and left side view of the invention applied to a mobile telephone.

FIG. 5 shows the front and right side view of the mobile telephone depicted in FIG. 4.

FIG. 6 illustrates the main actions that the software is required to undertake when a device of the invention is used for inserting characters or giving instructions.

FIG. 7 illustrates the main actions that the software is required to undertake when a device of the invention is used to move a cursor and where the index and ring fingers are used for clicking.

### DETAILED DESCRIPTION OF BEST MODE AND PREFERRED EMBODIMENTS

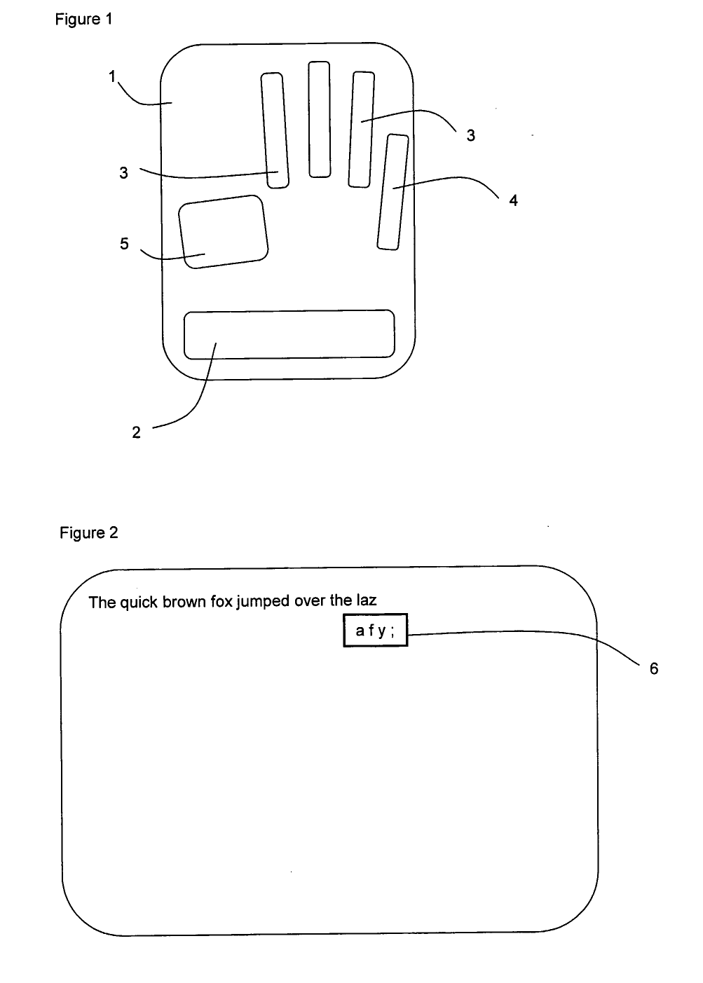

An embodiment of the invention (best mode) designed for right-handed use with a computer will now be described with reference to FIG. 1. FIG. 1 shows a base 1 approximately 20 cm in length, approximately 15 cm wide and approximately one cm deep. It is placed so that the long sides extend away from the user. There is a gel-filled wrist support 2 attached on the top face close to the edge nearest to the user. Four touch pads 3 and 4 are integrated into the top face. Three of these touch pads 3 are 1.5 cm wide and eight cm long, and lie almost parallel to each other and to the long side of the base, with a 0.5 cm space between them, but the invention can be produced with different dimensions to reflect the size of the hands that will use the device. Optionally the pads are slightly further apart from each other at the distant end than at the wrist end, as fingers tend to separate as they extend from the flexed position. The outer touch pad 4 is closer to the user than the other three, as the little finger is shorter than the other fingers. These pads 3,4 are offset towards the right of the base 1 so that the thumb pad 5 can be placed to their left. This thumb pad 5 is four cm by four cm, and is placed almost perpendicular to the other pads 3,4, angled so that it matches the arc described by the thumb moving right and left.

In use, the user rests his wrist on the wrist support 2 and relaxes his fingers. He then lowers his fingers so that they fall naturally onto their respective touch pads 3,4,5. Software notes the position of each finger along the long axis of its touch pad 3,4 and sets this as the reference point of its range. Similarly the thumb is lowered onto its touch pad 5 and its reference point is also set.

Each finger touch pad 3,4 is able to select one of a number of different characters and display it on the computer screen, this number in this embodiment being eight. These characters may be letters, numbers, punctuation, symbols or may represent functions normally found on a keyboard, such as “Page up” or “Delete” or other instructions. By moving each finger up to one cm forwards or backwards from its reference point the selected character is changed, depending on the position of the finger. At any time, therefore, four characters are displayed from the 32 available, where each finger selects from eight characters, and these can be changed by a small movement of the fingers. Although the required movement to display all of a finger's available characters is adjusted to be only two cm, the touch pads are longer than this to accommodate fingers of different lengths and differences in the comfortable degree of flexion of the fingers. Optionally the touch pads 3,4,5 are coated with a low-friction material to prevent injury to the fingers from repeated sliding across the surface.

The four selected characters are displayed on the computer or phone screen as shown in FIG. 2. In this embodiment they are presented in a horizontal row 6 below the cursor, and therefore below where one of them will be inserted. When the row of characters includes the character required for insertion the user lifts the finger corresponding to that character momentarily from the touch pad. This selects the displayed character and it is inserted into the document or if it represents an instruction the instruction is implemented. The software permits the user to select a short increase in finger pressure or a tap instead of a lifting of the finger if preferred.

The thumb in its reference point determines that the fingers display lower case characters, in a position closer to the fingers it determines that the fingers will display upper case and in one of two positions to the left of the reference point the fingers will display numbers or be used to instruct other functions including those that would be accessed by the function, control, Windows, alt and other keys on a standard keyboard. Optionally small ridges on the thumb touch pad give a tactile indication when the thumb crosses from allocating one set of characters to another. If four fingers each offer eight characters and four thumb positions a total of 128 characters or instructions are available. The software permits the number of thumb positions to be greater or less than four and the allocation of character sets to thumb positions to be changed.

If the little finger is removed from its touch pad 4 the finger touch pads 3 cease to offer characters, and instead offer a means to move the cursor as an alternative to a mouse or other pointing device. Movement of the thumb on its touch pad 5 moves the cursor left and right, and movement of the forefinger on its touch pad 3 moves the cursor up and down the screen. A tap on its touch pad by the ring finger is equivalent to a right mouse-click and a tap on its touch pad by the index finger is equivalent to a left mouse-click. Optionally a tap by the thumb could be recognised as a left click and a tap by the forefinger could be recognised as a right click. The software permits the allocation of these actions between the touch pads to be altered.

Some of the software required to control the touch pads and the screen display is run on a processor incorporated into the invention and some of it is run on the processor of the host computer. If it is wished to apply the invention to a host computer or other device without installing driver software on it the processor within the invention has the ability to run all of the necessary software. The software that controls the invention offers the option to adjust features including but not limited to the following:
the length of finger travel required to encompass all available characters or instructions
the number of characters or instructions available from each finger
the number of fingers used, to allow for users with missing or unusable fingers, and the option of using one finger to replace a missing or inoperative thumb
the number of thumb positions used and the length of thumb travel required to encompass all available character or instruction sets
the character selected by each combination of finger, finger position and thumb
the font, size, shape, colour and position of the character display
when the fingers are being used to move the cursor, the relative distances moved by the fingers and the cursor, and to what extent these vary according to the speed of the finger movement
the change in finger contact area that is recognised as a finger lift and a tap, used to emulate a mouse-click.

An optional feature within the software can rank the characters by their frequency of usage and to distribute these around the reference points of the fingers for each different user, or can select one of a plurality of standard patterns.

Touch pads currently report only one finger position, but when touch pads that can identify the position, movement and contact area of more than one finger become available one large touch pad could replace the separate touch pads described herein.

The software and electronics required to operate the touch pads and the software required to display the characters on a screen are readily available or easily produced within the existing art, and have not been described herein.

Optionally keys may be located on the base, to provide an alternative to the entry of characters or instructions via the touch pads. Optionally a standard pointing device such as but not limited to a touch pad giving two position co-ordinates, a tracker ball or a joystick may be included in the base as a means of moving the cursor as an alternative to using the primary touch pads. Optionally the thumb pad is larger than the size described above and acts as a normal touch pad giving two position coordinates and moving a cursor when the fingers are removed from the finger touch pads. Optionally left and right click buttons are located on the base. Optionally indicator lights are located on the base, for purposes including showing that “Caps Lock” is on.

Optionally the invention incorporates a system to switch on and off, or otherwise change the status of, the electric current available to itself in order to reduce the usage of electricity and particularly the drain on batteries when the invention is not in use. In some embodiments this is achieved by the wrist support incorporating a mechanism for detecting the weight of the wrist on the support or by detecting changes in the pressure within any gel or fluid in the support. This weight or pressure may be detected by various means, including but not limited to electromechanical, piezo-electric or by pressure-sensitive semi-conductors. In other embodiments this control is achieved by one of the finger or thumb touch pads acting as the switch, reducing or cutting off electrical power to the other pads when it has detected no finger or thumb contact on itself for a set period. It may alternatively be achieved by a sensor detecting the proximity of the wrist or hand, this sensor operating by established sensing technologies including but not limited to passive infra-red or capacitance.

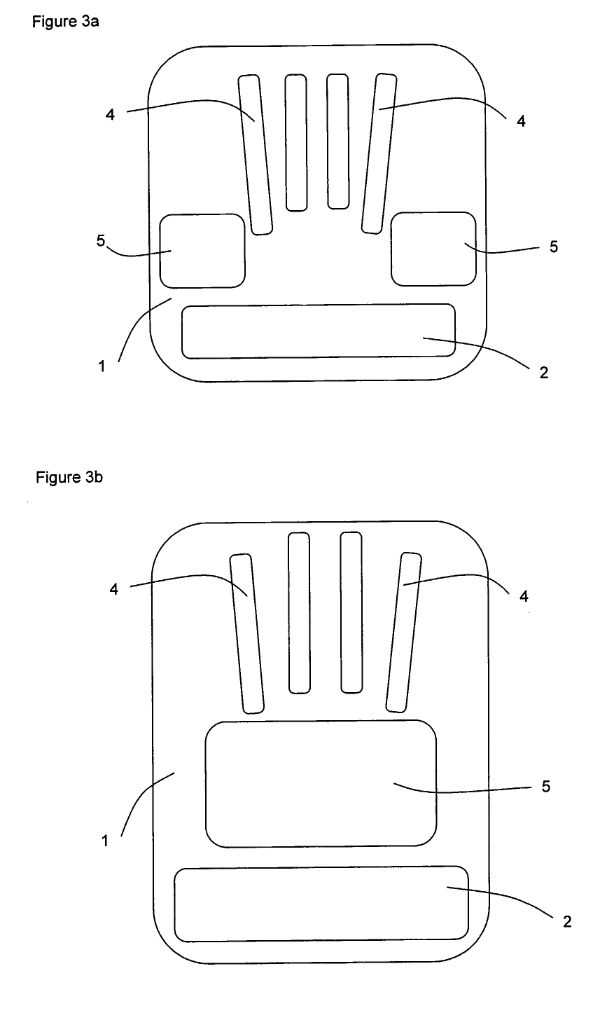

FIGS. 3a and 3b show two further embodiments of the invention in which the device is designed for use by the right or the left hand. As shown in FIG. 3a, there are two thumb touch pads 5, one on either side of the finger pads, and the outer two finger pads 4 are elongated so that both are suitable for the little finger or for the index finger. A wrist support 2 is positioned below the thumb pads 5. In the device shown in FIG. 3b, one large thumb touch pad 5 is positioned below the finger pads, and extends across the width of the finger pads defined by the outer two finger pads 4, so as to be accessible both by the left-hand thumb when the left hand is used and by the right-hand thumb when the right hand is used. A wrist support 2 is positioned below the thumb pad 5.

The embodiments of the invention described above are for stand-alone units, but the invention can be incorporated into or used with a range of devices including but not limited to a desktop computer, portable computer, the base of a computer screen, a telephone or a personal digital assistant.

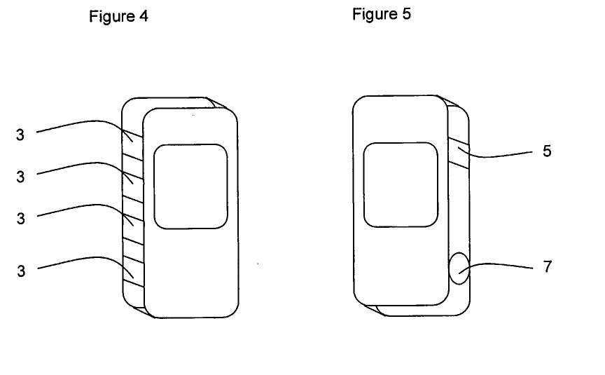

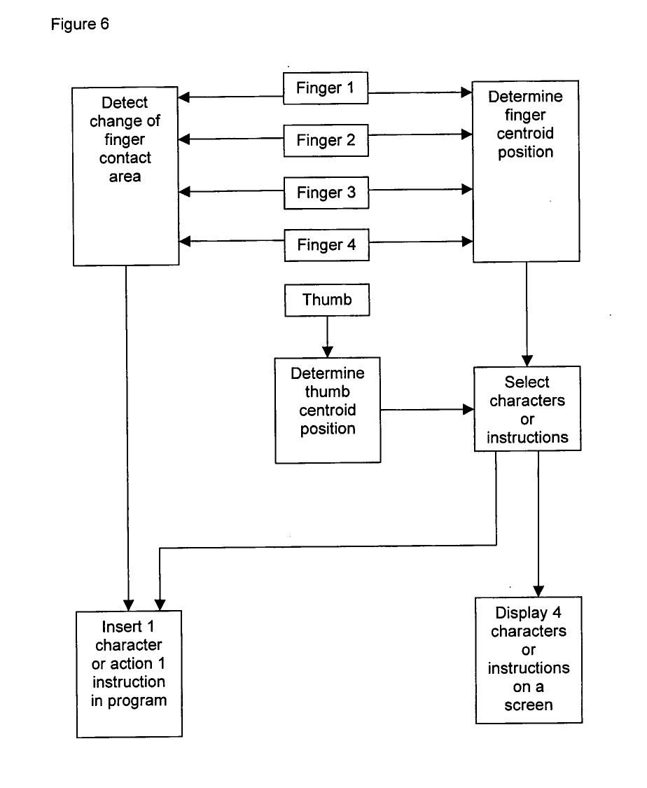

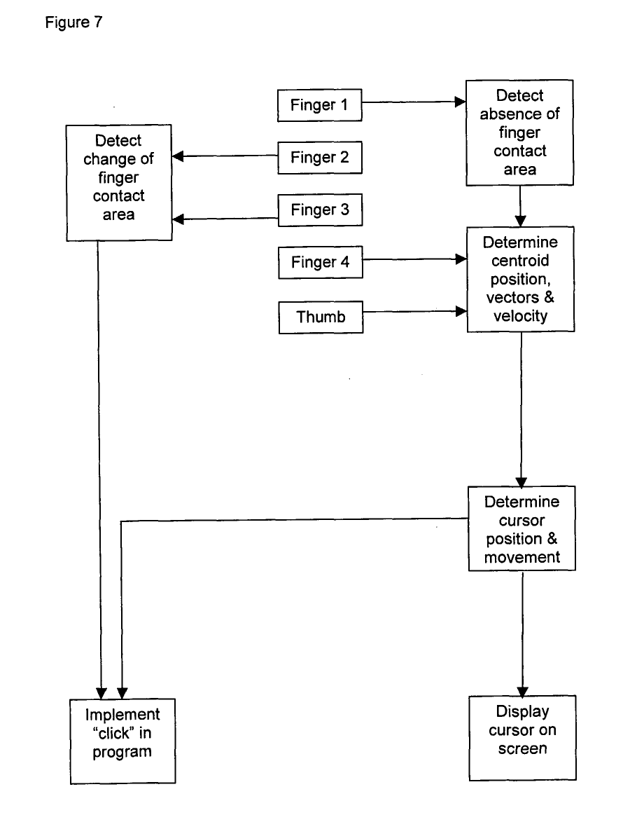

FIGS. 4 and 5 show an embodiment of the invention in a mobile telephone, in which the phone is designed to be held in the right hand with the finger pads 3 located on the left side of the phone as shown in FIG. 4. The movement available for selecting the character is limited to the distance from the back to the front face of the phone, although a curved side can increase this available distance, but this is sufficient to discriminate between the necessary number of characters. The touch pad 5 for the thumb is on the right side of the phone towards the top, shown in FIG. 5, and the direction of movement is again between the front and back faces. In use the phone is gripped in the right hand between the ball of the thumb and the fingers. The fingers are moved to display and select the required character. An optional sixth touch pad 7 is provided on the right hand side of the phone to make contact with the ball of the thumb, in which case only when the software senses all six points of contact does the invention become active, and this prevents inadvertent operation of the phone. This embodiment could be designed for holding in the left hand by placing the pads on the opposite side to those described above.

A further embodiment (not shown) is in a mobile telephone designed for use in either hand. This has four touch pads on each side, and the software determines which set of touch pads are used for the fingers and which set are used for the tip and optionally the ball of the thumb. This allocation of the two sets may be actively made by the user selecting right or left handed use, or the software may identify which pads are in contact with a finger or thumb and allocate the sets appropriately.

1. A device for data entry into an electronic device having a screen, comprising:
a first touch pad (5) for the thumb and two to four touch pads (3,4) for the fingers, arranged on the device in a pattern corresponding to the natural thumb and finger tip positions of the thumb and fingers when relaxed;
each finger touch pad (3,4) extending in backward and forward directions from a reference point along a line or arc corresponding to the natural path of the finger tips followed when the fingers are flexed and extended;
the thumb touch pad (5) extending in left and right directions from a reference point along a line or arc corresponding to the natural path of the thumb followed when the thumb is moved left and right;
position detecting means to detect the position of the thumb and each finger tip along each of the thumb and finger touch pads (3,4,5), wherein a plurality of positions in the backward direction and a plurality of positions in the forward direction from the reference point of each finger touch pad (3,4) are detectable;
finger data selection means to select for each finger a character or instruction corresponding to the detected position of a finger tip when in contact with a finger touch pad (3,4);
thumb option selection means to select an option corresponding to the detected position of the thumb when in contact with the thumb touch pad (5);
selection display means to display on the screen the character or instruction selected on each finger touch pad (3,4) according to the option selected on the thumb touch pad (5); and
data entry detecting means to detect tapping or lifting of a finger on or from a finger touch pad (3,4) and enter a selected character or instruction displayed on the screen into the electronic device based on the character or instruction selected on the finger touch pad (3,4) for which tapping or lifting is detected and based on the option selected on the thumb touch pad (5).

2. A device according to claim 1 wherein said data entry detecting means detects tapping of a finger on a finger touch pad (3,4) and enters a displayed, selected character or instruction into the electronic device based on the character or instruction selected on the finger touch pad (3,4) for which tapping is detected and based on the option selected on the thumb touch pad (5).

3. A device according to claim 1 wherein said data entry detecting means detects lifting of a finger momentarily from a finger touch pad (3,4) and enters a displayed, selected character or instruction into the electronic device based on the character or instruction selected on the finger touch pad (3,4) for which lifting is detected and based on the option selected on the thumb touch pad (5).

4. A device according to claim 1, wherein the number of finger touch pads (3,4) is four.

5. A device according to claim 1, further comprising a second thumb touch pad (5), wherein the first and second thumb touch pads (5) are disposed one on either side of the finger touch pads (3,4), for either-handed data entry.

6. A device according to claim 1, wherein the thumb touch pad (5) is disposed below the finger touch pads (3,4) and is sufficiently large to enable either-handed data entry.

7. A device according to claim 1, in paired combination with another said device of opposite- or either-handedness, for two hand data entry.

8. A device according to claim 1, further comprising pointing means wherein in the absence of any position detected on one or two of the finger touch pads (3,4), the pointing means points or moves a cursor and enters instructions, based on finger positions detected on one or two other finger touch pads (3,4) and on the thumb touch pad (5).

9. A device according to claim 1, further comprising pointing means wherein in the absence of any position detected on the finger touch pads (3,4), the pointing means points or moves a cursor and enters instructions, based on positions detected on the thumb touch pad (5).

10. A device according to claim 1, wherein the plurality of positions detectable in each of the backward and forward directions from the reference point for each finger touch pad (3,4) is 4.

11. A device according to claim 1, wherein 3 to 6 positions are detectable for the thumb touch pad (5).

12. A device according to claim 1, further comprising selection availability display means to display on the screen some or all of the characters or instructions available for selection on each finger touch pad (3,4) according to the option selected on the thumb touch pad (5).

13. A device according to claim 1, wherein the electronic device is a computer, PDA or mobile phone.

14. A device according to claim 13, wherein the electronic device is a computer and the data entry device further comprises a mounting for ergonomically orienting the data entry device for the user.

15. A device according to claim 14, wherein said mounting is adjustable to enable the data entry device to be oriented in any of a plurality of positions.

16. A device according to claim 13, wherein the electronic device is a computer and the data entry device further comprises a wrist support and power control means operable via the wrist support, for controlling the power supply or power management for the data entry device.

17. A device according to claim 13, wherein the electronic device is a mobile phone having touch pads arranged thereon and operable for left- or right-handed use as a thumb touch pad (5) and four finger touch pads (3,4) with the thumb touch pad (5) disposed on one side face of the phone and the four finger touch pads (3,4) disposed on the other side face of the phone.

18. A device according to claim 17, further comprising a touch pad (7) operable for the ball of the thumb disposed on said one side face of the phone below the thumb touch pad (5).

19. A device according to claim 18, wherein the position detecting means can further detect the ball of the thumb on its touch pad (7), and the device further comprises device activating means to activate the device only when the position detecting means has detected all of the thumb tip, finger tips and ball of the thumb on their respective touch pads (3,4,5,7).

20. A device according to claim 13, wherein the electronic device is a personal digital assistant (PDA) having a thumb touch pad (5) and four finger touch pads (3,4) arranged thereon with the thumb touch pad (5) disposed on a minor face of the PDA and the four finger touch pads (3,4) disposed on an external major or internal major face of the PDA.

21. A device according to claim 1, wherein the selection display means displays the selected characters or instructions on the screen in a fixed or moving window portion (6) thereof.

22. A device according to claim 21, wherein said window portion (6) is moved progressively along with the character entry position or text cursor as the characters or instructions are entered.

23. A device according to claim 1, wherein the thumb touch pad (5) and four finger touch pads (3,4) are part of one large touch pad that can identify the position, movement and contact area of more than one finger.

24. A device according to claim 1, wherein the thumb touch pad (5) and four finger touch pads (3,4) are separate touch pads.
